(19) United States
(12) Patent Application Publication
(10) Pub. No.: US 2008/0288319 A1
(43) Pub. Date: Nov. 20, 2008

(54) SYSTEM AND METHOD FOR INTERACTING WITH PARTICIPANTS OF A FUTURE EVENT

(75) Inventors: James E. Christensen, Cortlandt Manor, NY (US); Thomas D. Erickson, Minneapolis, MN (US); Peter K. Malkin, Ardsley, NY (US); John T. Richards, Chappaqua, NY (US); Jeremy Sussman, Bedford Hills, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/181,530

(22) Filed: Jul. 29, 2008

Related U.S. Application Data
(63) Continuation of application No. 11/197,636, filed on Aug. 4, 2005.

(51) Int. Cl. G06Q 10/00

(52) U.S. Cl. 705/8; 705/7

(57) ABSTRACT

A system and method for conducting on-line meetings that includes functionality for scheduling and calendaring on-line meetings or events. The system functionality for scheduling and calendaring on-line meetings or events includes enhanced functions for specifying actions to be performed at the time of the meeting and rendering the nature of such actions contingent upon the members attending a scheduled meeting.

### RELATED APPLICATIONS

This application is a continuation of U.S. patent application Ser. No. 11/197,636, filed on Aug. 4, 2005.

### FIELD OF THE INVENTION

The present invention relates generally to the systems providing on-line meetings, e.g., including functionality for scheduling and calendaring on-line meetings or events. More particularly, the present invention is directed to a system and method for scheduling and calendaring on-line meetings or events having enhanced functionality for specifying actions to be performed at the time of the meeting and rendering the nature of such actions contingent upon the members attending a scheduled meeting.

### DISCUSSION OF THE PRIOR ART

Many prior art systems are directed means for collaborating on-line, such as by participating in on-line meetings and events. Representative systems and methodologies enabling scheduling and calendaring of on-line events are described in U.S. Patent Publication Nos. 2004/0005484; 2004/0047461; 2003/0108002; 2003/0158900; 2003/0235279; U.S. Pat. Nos. 6,275,575; 6,477,543; 6,418,214; 6,658,427; 6,064,977; 6,016,478; 5,960,406; 5,790,974; 5,701,423 and J. Webb, “Uniting the Workforce with Collaboration”, Information Management Technology, The Journal of Cimtech, Volume 36, Number 2, April-June 2003; Pages 72-74.

U.S. Patent Publication No. US2003/0235279 describes a method involving a voice-based conference call, in which the people who attend the meeting are monitored, and which permits those who have attended to receive a summary of the meeting; it does not discuss how an arbitrary user might set up an action prior to the meeting.

Determination of an amount of users participating in a multi-user telephone conference is accomplished with functionality described in commonly-owned, co-pending U.S. patent application Ser. No. 10/346,246 filed Jan. 16, 2003 (now United States Patent Publication No. 2004/0141605), entitled METHOD AND SYSTEM FOR AUTOMATIC REAL-TIME MEETING ATTENDANCE TRACKING AND REPORTING IN A MULTI-USER TELEPHONE CONFERENCING ENVIRONMENT.

An article entitled “United the Workforce with Collaboration” (Information Management & Technology, V.36, No.2, April-June 2003 provides a very general short overview of the past, present and future of collaboration while alluding to group calendaring and scheduling systems.

While such systems described in these prior art references address various aspects of participating in on-line meetings and/or events, none of them address: (a) any action to be performed at the time of the meeting, nor (b) the nature of that action being contingent upon who actually attends the meeting (or other characteristics of the actual meeting).

Currently, there exists a need for a system and method that enables a user to schedule an on-line meeting and event, specify an action to be performed contingent upon the participants attending the meeting, and then have the action performed at the time of the event to only those users that actually attend the event.

### SUMMARY OF THE INVENTION

It is an object of the present invention to provide a system, method and computer program product for conducting on-line meetings that includes functionality for scheduling and calendaring on-line meetings or events. The system functionality for scheduling and calendaring on-line meetings or events includes enhanced functions for specifying actions to be performed at the time of the meeting and rendering the nature of such actions contingent upon the members attending a scheduled meeting.

According to a first embodiment of the invention, there is provided a system, method and computer program product for conducting an on-line meeting, the system comprising:
a means for storing data relating to a target group of users participating in an on-line meeting, the data including information representing an action to be executed for the target group and, data including information representing a trigger condition for automatically executing the action;
a means for monitoring occurrence of the trigger condition; and
a means for executing the action for the target group participants upon detecting occurrence of the trigger condition.

The system further comprises: a client device providing an interface enabling a user to define the target groups, specify trigger conditions and actions to be executed for defined target group members; and, a server for receiving information representing the defined one or more of the target groups, specified trigger conditions and actions and updating the storing means, the client in communication with the server over a network connection.

It is a characteristic of the present invention that the target group of users participating in the on-line meeting may initially be undeterminable.

### BRIEF DESCRIPTION OF THE DRAWINGS

The objects, features and advantages of the present invention will become apparent to one skilled in the art, in view of the following detailed description taken in combination with the attached drawings, in which:

FIG. 1 is a schematic showing an example network architecture 100 including the major technology infrastructures of the system according to the invention;

FIG. 2 depicts a block diagram of the future group server 1010 used in the inventive system;

FIG. 3 depicts is a flow chart showing the server control process 2040 implemented by the system of the present invention; and,

FIG. 4 is a flow chart showing the overall methodology implemented in the system of the present invention.

### DETAILED DESCRIPTION OF PREFERRED EMBODIMENT

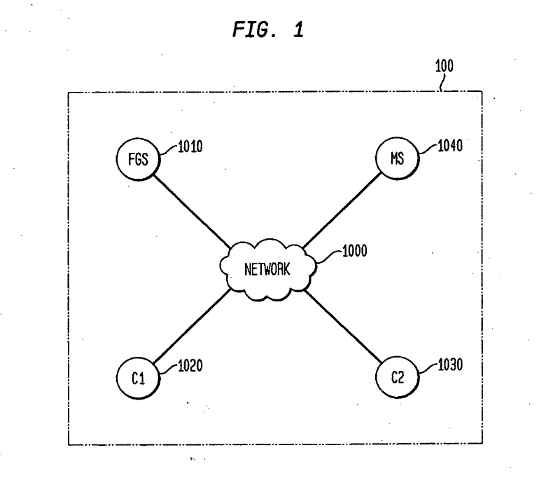

The present invention permits a user to perform the following: (1) schedule an on-line meeting; (2) specify that a particular document be sent; and (3) have the requested document sent to only those users who actually attend the meeting when the meeting takes place. As will be described in detail with references to FIGS. 1-4, an exemplary embodiment of the invention enables a first user to perform these actions from a web browser running on his/her computer, which, in turn, communicates with a web server via a communications network. In the preferred embodiment, the web server will provide to the client's web browser with a fully functioning application (e.g., an applet), which will handle all interactions between the user and the application, this application being downloaded via a web request (e.g., an HTTP GET request that retrieves the contents of a file specified in the URL).

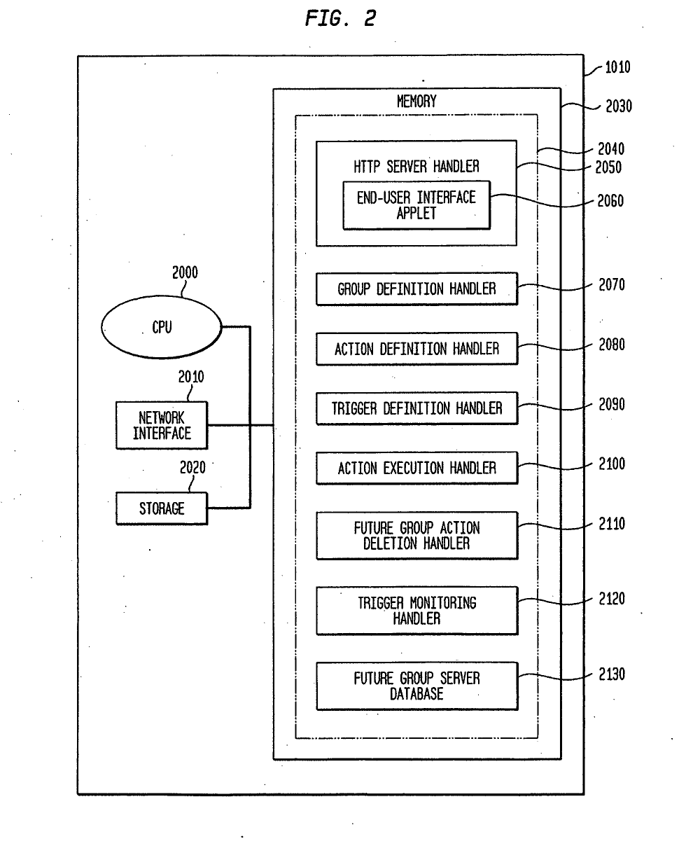

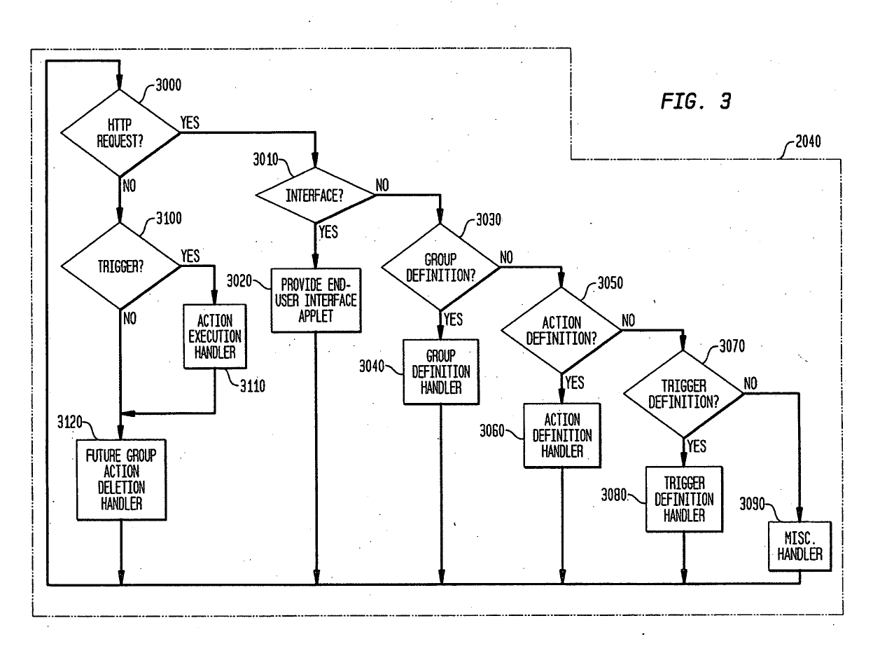

FIG. 1 depicts an example network topology 100 providing an execution environment implementing the functionality of the invention. As shown in FIG. 1, there one Future Group Server FGS 1010 (described in detail with reference to FIGS. 2 and 3), an online meeting server MS 1040, and two client nodes C1 1020 and C2 1030, which can communicate with each other through network 1000. The network 1000 includes, but is not limited to the Internet, an internal intranet, or a wireless on wired telecommunication network. Although only two client nodes, C1 1020 and C2 1030 are pictured in FIG. 1, the system is applicable to any greater number as well. It is understood that although the preferred embodiment involves a Web-based (i.e., HTTP) network application, other forms of network communication are also applicable, such as a raw sockets-based client/server architecture.

Examples of platforms that support the clients C1 1020 and C2 1030 include any device that can act as web client (i.e., including functionality for executing a web browser application and that can communicate with the server 1010 via the network 1000). Such devices include, but are not limited to, an IBM ThinkPad running Windows 95 and a web browser such as Microsoft's Internet Explorer. Clients are provided network-connectable mobile (i.e., portable) functionality including devices such as those sold under the trademark WorkPad by IBM, as well as smart cellular telephones (i.e., devices which can act as a cellular telephone as well as run network applications, like web browsers), e.g., Nokia 90008 by Nokia.

The Online meeting server MS 1040 provides online conferencing (e.g., a meeting) utility for web clients. Examples of platforms that support the MS 1040 include, but are not limited to: an IBM Workstation running Windows XP and a web-based online meeting service, such as Lotus Notes's eMeeting server, or a web-based news group server.

FIG. 2 depicts a more detailed component diagram of the Future Group Server FGS 1010. This server 1010 may comprise any computing node adapted to act as an HTTP server, including, but not limited to: products sold by IBM such as ThinkPad or PowerPC®, running the operating system and server application suite sold by Microsoft, e.g., Windows® NT, or a Linux operating system.

As shown in FIG. 2, the FGS server 1010 preferably includes a processor device, e.g., CPU 2000, a network interface 2010, a storage device 2020 such as a magnetic or optical disk storage or a direct access storage device (DASD), and a memory 2030, such as RAM. According to the present invention, the server logic 2040 is preferably embodied as computer executable code that is loaded from a remote source (e.g., over the network 1000 via the network interface 2010), local permanent optical (CD-ROM), magnetic storage (such as disk), or DASD 2020 into memory 2030 for execution by CPU 2000. As will be discussed in greater detail hereinbelow, the memory 2030 preferably includes computer readable instructions, data structures, program modules and application interfaces forming the following components: an HTTP Server Handler component 2050, able to provide an End-User Interface Applet 2060; a Group Definition Handler component 2070; an Action Definition Handler component 2080; a Trigger Definition Handler component 2090; an Action Execution Handler component 2100; a Future Group Action Deletion Handler component 2110; a Trigger Monitoring Handler component 2120; and a Future Group Server Database 2130.

The HTTP Server Handler 2050 particularly may be any application that implements functionality for responding to HTTP communications, and may be embodied as the WebSphere® product (a servlet execution engine) sold by IBM.

The End-User Interface Applet 2060 is an applet a given user can retrieve from the Future Group Server 1010 via its HTTP Server Handler component 2050 to the web browsers running on the client nodes C11020 or C2 1030. This applet provides an interface enabling an end-user to communicate with the Group Definition Handler component 2070, the Action Definition Handler component 2080, and the Trigger Definition Handler component 2090. Skilled artisan will appreciate that the interface provided by the End-User Interface Applet 2060 could also be preloaded or preinstalled on the client C1 1020 or C2 1030. Such artisans will also appreciate that the interface provided by the End-User Interface Applet 2060 can also be implemented as a socket-based application.

The Future Group Server Database 2130 allows the Future Group Server 1010 to store, modify and delete data related to groups, actions and triggers. This database can include, but it not is not limited the DB/2 product sold by IBM, Skilled artisans will appreciate that the Future Group Server Database 2130 may include a service that runs on another server and is accessible by the Future Group Server 1010 via the network 1000.

The Group Definition Handler component 2070 provides functionality allowing a user from their web browser or like interface device- to define a target group of users to which they want one or more actions applied. According to the invention, exemplary target user groups and user-defined attendee (or invitee) member specifications may include, but are not limited to, one or more of the following examples:
1. All those who attend a particular online meeting (e.g., the company's kickoff online meeting);
2. All those who attend a re-occurring online meeting (e.g., a department's weekly meeting) this group being recomputed at each instance of the meeting;
3. All those who attend all or some specified porting on a given online meeting (e.g., the entire kickoff party);
4. All those who attend a given an online meeting, even those who arrive late;
5. All those who attend a given an online meeting and stay for a specified period of time (e.g., at least ½ hour, the entire event, or the last ½ hour);
6. All those at a particular location (e.g., in NY Times Square). It is understood that this definition requires the Future Group Server to implement or have access to some form of location awareness service that can return the location of one or more users.

Each such user-defined group definition is stored in the Future Group Server Database 2130. In the preferred embodiment, whenever a new group is defined, a unique ID for the group is returned to the creating end-user by the Group Definition Handler component 2070.

The Trigger Definition Handler component 2090 enables an end-user from their client node (C1 1020, or C2 1030) to specify a condition, the Trigger Definition Handler 2090 returning a unique trigger ID for each such specification. These condition specifications or “triggers” are used by the Future Group Server 1010 to determine when a previously specified action is to be executed. Example triggers can include, but are not limited to:
1. A time or date, (e.g., 12/25 24:00:00);
2. An event (e.g., the day of the US presidential election);
3. The number of participants in a given meeting (e.g., >5, or >−8);
4. The identity of one or more members of the target group when the action is executed (namely, the current target group), (e.g., current target group includes a manager as indicated by jsmtih@foo.corp.com);
5. Whether one or more particular users are not a member of the current target group (e.g., a current target group does not contain a manager jsmith@foo.corp.com);
6. The behavior of one or more users (e.g., postings are being made to the online meeting at least one per minute and these postings are being made by three or more users); and
7, The type of behavior displayed by one or more users (e.g., the average length of postings to online meeting for the past half hour has been greater than 5 words).

All such triggers are stored in the Future Group Server Database 2130. One with ordinary skill in the art will appreciate that a given trigger may be composed of the Boolean combination of several conditions, including previously defined triggers; these triggers indicated using their unique trigger ID.

The Action Definition Handler component 2080 enables an end-user—from their client node (C1 1020 or C2 1030)—to specify an action that is to be executed by the Future Group server 1010, the given action being applied to a predefined group given a predefined trigger condition. In the preferred embodiment, such action definitions include three elements: (1) a description of the action, (2) the ID of the group to which the action is to be applied, and (3) an invocation trigger, the ID of the trigger condition which must be true for the action to be executed. Examples of actions include, but are not limited to:
1. Sending a data object, including the current version of a particular document to devices associated with the current target group (e.g., sending each member of the group the latest version of a set of talk slides);
2. Giving the current target group members access privilege to a particular network-accessible resource (e.g., a special chat room);
3. Sending invitations to one or more users for them to join the current online meeting;
4. Scheduling a future meeting with only the members of the current target group; and
5. Saving the current target group in the Future Group Server Database 2130 for later use.

The system further allows for the action definitions to include an indication of the whether the given action may be executed more than once. Additionally, the system allows for the action definition to include a deletion trigger, this being the ID for a trigger, which, if true, causes the current action definition and triggers to be deleted from the Future Group Server Database 2130.

The Trigger Monitoring Handler component 2120 scans through all action definitions and checks the invocation triggers for each, invoking the Action Execution Handler component 2100 on any and all those whose triggers are true. For example, if it is now Wednesday June/15/2005 at 12:00, the triggering condition for action #123, then the ID for this action is passed to the Action Execution Handler component 2100.

The Action Execution Handler 2100 executes the action passed to it by the Trigger Monitoring Handler 2120. This involves first determining the current members of the target group. Thus, if action #123's target group were defined as “All attendees of online meeting #987, the Action Execution Handler 2100 first checks with the meeting server MS 1040 and then sets the current target group to include all those who were attending meeting #987. Participants of an on-line meeting (including the amount of participants and their identities) can be determined in accordance with teachings well known in the art. For example, in on-line meeting applications, such as a standard online chat, IBM's Sametime Meeting, or Microsoft NetMeeting, a list of all current participants is provided to all active users of a given meeting. The list of current users can be retrieved by the Action Execution Handler 2100 either directly, if the given meeting's server provides such programmatic access (e.g., via an API), as does IBM's Sametime meeting, or by parsing (“screen scraping”) the information from the visible response returned to standard users. Skilled artisan will appreciate that in situations where a given online meeting service does not provide remote access to the list of current users, e.g., a standard telephone conference, an associated participant-listing service—one that the Action Execution Handler 2100 could access remotely—could be provided, thus the participant-listing service providing a dynamically updated list of all active participant in the given meeting. Skilled participant will also appreciate that the information provided by the participant-listing service could be obtained either using a proprietary (local) access method, if such method exists, or by having the participants manually sign in and out of the given meeting via the participant-listing service.

The Action Execution Handler 2100 would then execute the action specified by #123 to all of the members of the current target group. In the preferred embodiment, every time a given action is executed, its definition is updated to indicate this.

Furthermore, if a given action is executed multiple times, the members of the current target group may change. For example, if a given action is executed every Wednesday and is to be applied to only those attending a particular chat group, the current target group is likely to change from week to week, since the same group of users do not always attend.

In one illustrative embodiment, if a definition of the current target group is “All those who attend meeting XXX, even those who arrive late,” then the Action Execution Handler 2100 will monitor the meeting for its full duration, executing the specified action to the initial “on-time” attendees, and then executing this same action to any users who join the meeting late. In cases where the group is defined as “All those who attend the meeting for at least 30 minutes,” the Action Execution Handler 2100 will have to monitor the meeting for at least 30 minutes, only adding a given user to the current target group after they've been in the meeting for 30 minutes.

The Future Group Action Deletion Handler 2110 checks all action definitions to determine if any should be deleted from the Future Group Server Database 2130. This includes deleting definitions of executed actions marked as one-time-only. It also includes deleting any definitions whose deleting triggers are true, So for example, if it is now the end of the school and this matches action #234's deletion trigger, the Future Group Action Deletion Handler 2110 will delete action #234 from the Future Group Server Database 2130.

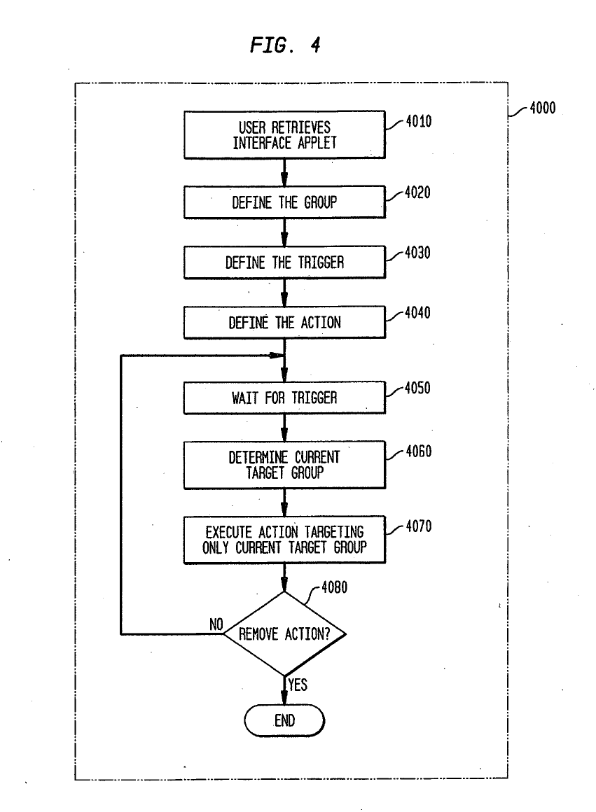

FIG. 3 depicts a detailed flow diagram of the methodology 2040 implemented by the Future Group Server 2040. As shown, FGS 1010 checks whether is has received an HTTP request in step 3000. If the FGS has received an HTTP request, the request is checked in step 3010 to determine if it is a request for the End-User Interface Applet 2060. If the request is for the End-User Interface Applet 2060, this applet 2060 is returned to the requesting user in step 3020, following which control resumes at step 3000. Details regarding the methodology employed by use of the applet will be described herein with respect to FIG. 4. If the request is not for the End-User Interface Applet, the request is checked in step 3030 to determine if it is a message for invoking the Group Definition Handler 2070. If the request is a message for the Group Definition Handler component 2070, the message is passed to the Group Definition Handler 2070 in step 3040, following which control resumes at step 3000. If the request is not a message for the Group Definition Handler component 2070, the request is checked in step 3050 to determine if it is a message for the Action Definition Handler component 2080. If the request is a message for the Action Definition Handler component 2080, the message is passed to the Action Definition Handler 2080 in step 3060, following which control resumes at step 3000. If the request is not a message for the Action Definition Handler component 2080, the request is checked in step 3070 to determine if it is a message for the Trigger Definition Handler 2090. If the request is a message for the Trigger Definition Handler, the message is passed to the Trigger Definition Handler 2090 in step 3080, following which control resumes at step 3000. If the request is not a message for the Trigger Definition Handler component, then a miscellaneous handler, providing functionality beyond the scope of the present invention, is invoked at step 3090, following which control continues at step 3000.

Referring back to step 3000, if the input is not an HTTP request, then the Trigger Monitoring Handler 2120 is invoked at step 3100 to determine if any invocation triggers are true. If it is determined that an invocation trigger is true, the Action Execution Handler 2100 is invoked in step 3110 for executing the action passed to it by the Trigger Monitoring Handler 2120. Following this, or if the Trigger Monitoring Handler 2120 did not find any active triggers, the Future Group Action Deletion Handler 2110 is invoked in step 3120 to check all action definitions to determine if any should be deleted from the Future Group Server Database 2130, following which control continues at step 3000.

FIG. 4 depicts an overview of the methodology 4000 employed by the system 100 of the invention. As shown in step 4010, a user first retrieves the End-user Interface Applet 2060 from the Future Group Server's HTTP Server Handler 2050 and runs it on their client node (C1 1020 or C2 1030). In Step 4020, the user defines a group by sending a message to the Group Definition Handler 2070. For example, they could define their group as all those online attendees of a company or group's weekly status meeting, this group being given the ID GROUP_666. Next, in step 4030, the user is able to define a trigger by sending a message to the Trigger Definition Handler 2090. For example, the user could define a trigger such as “Wednesday morning at 9:00,” this trigger being given the ID TRIGGER_777. In step 4040, the user employs the applet 2060 running on their client node (1020 or 1030) to contact the Action Definition Handler 2080 to define an action. For example, the user could specify that the current version of their meeting presentation slides be sent to all attendees (group GROUP_666) the morning of each meeting (invocation trigger=TRIGGER_777); this action being given the ID ACTION_888. In this example, the user may specify a deletion trigger of Dec. 31, 2005 so that this action stops being executed the last day of the year 2005. In step 4050, the Trigger Monitoring Handler 2120 scans through all of the defined invocation triggers repeatedly until it finds one that is true. In the case of the example, this means that it will wait until Wednesday at 9:00 A.M. (TRIGGER_777). When this condition becomes true, the Trigger Monitoring Handler 2120 will send the ID of any action with this as its invocation trigger—ACTION_888 in the case of this example to the Action Execution Handler 2100. In step 4060, the Action Execution Handler 2100 first determines all members of the current target group by consulting the group definition (that associated with ID GROUP_666 in this example), and then determining the relevant set of users. In this example, this includes anyone participating in (connected to) the group's weekly status meeting on meeting server 1040. Next, in step 4070, the Action Execution Handler 2100 executes the specified action, e.g., sending the current version of the user's meeting presentation slides to all members of the target group. Following this, in step 4080, the Future Group Action Deletion Handler 2110 is invoked to determine is any of the deletion triggers have become true, deleting all such action definitions from the Future Group Server Database 2130. In the example scenario described, no such trigger occurs until the end of the year, so ACTION_888 remains in the database 2130.

As shown in FIG. 4, control then returns to step 4050, where the Trigger Monitoring Handler 2120 waits for a trigger to fire, e.g., Wednesday at 9:00 AM, in the example described. It is understood that, in this example, when the next Wednesday morning does arrive (1) the target group determined by the Action Execution Handler 2100 in step 4060 may differ from that of the previous week, and (2) the document—the user's current version of the meeting presentation sent to all members of the target group, may have changed.

When the deletion trigger for the given action does occur—the end of the 2005, in the case of this example—the Future Group Action Deletion Handler 2110 deletes the relevant action definition (ACTION_888 in the example) from the Future Group Server Database 2130, and the current invention exits with respect to the particular action specification (ACTION_888 in the example), as indicated at step 4080.

The present invention has been described with reference to flow diagrams and/or block diagrams of methods, apparatus (systems) and computer program products according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer-readable or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention.

Having thus described our invention, what we claim as new, and desire to secure by Letters Patent is:

1. A system for conducting an on-line meeting comprising:
a means for storing data relating to a target group of users participating in an on-line meeting, said data including information representing an action to be executed for said target group and, data including information representing a trigger condition for automatically executing said action;
a means for monitoring occurrence of said trigger condition;
a means for executing said action for said target group participants upon detecting occurrence of said trigger condition.

2. The system as claimed in claim 1, wherein said target group of users participating in said on-line meeting is undeterminable.

3. The system as claimed in claim 1, further comprising:
a client device providing an interface enabling a user to define said target groups, specify trigger conditions and actions to be executed for defined target group members; and,
a server for receiving information representing said defined one or more of said target groups, specified trigger conditions and actions and updating said storing means, said client in communication with said server over a network connection.

4. The system as claimed in claim 1, implemented in an on-line meeting environment conducted over one of: the Internet, an internal intranet, a wireless communication network or wired communication network.

5. The system as claimed in claim 3, wherein said server includes a group definition function for initiating update of said storing means with said received target group definition and adding new target groups for storage.

6. The system as claimed in claim 3, wherein said server includes a trigger definition function for initiating update of said storing means with said received information representing a trigger condition, each trigger condition having an associated ID.

7. The system as claimed in claim 6, wherein a trigger condition comprises: a specified time or date, a condition is a specified event, a number of participants in a given meeting, a specified behavior of a participant or, attendance of a specified participant, and combinations thereof.

8. The system as claimed in claim 6, wherein said means for executing comprising an action execution function for receiving an action execution signal, and in response determining participants of said specified group and, performing a defined action in response for all members defined in said target group.

9. The system as claimed in claim 8, wherein said means for monitoring comprises a trigger monitoring handler function for scanning through defined invocation triggers until it finds a trigger that resolves true and generating said action execution signal in response.

10. The system as claimed in claim 9, wherein a trigger condition is specified as a Boolean combination of more than one trigger conditions specified by unique IDs associated with said trigger conditions, said monitoring handler function for scanning through defined invocation triggers comprising said Boolean combination until it finds a combination resolving true, and generating said action execution signal in response.

11. The system as claimed in claim 3, wherein said server includes an action execution function for initiating update of said storing means with said received information representing actions to be executed.

12. A method for conducting an on-line meeting comprising:
storing data relating to a target group of users participating in an on-line meeting, said data including information representing an action to be executed for said target group and, data including information representing a trigger condition for automatically executing said action;
monitoring for occurrence of said trigger condition; and,
executing said action for said target group participants upon detecting occurrence of said trigger condition.

13. The method as claimed in claim 12, wherein said target group of users participating in said on-line meeting is undeterminable.

14. The method as claimed in claim 12, further comprising:
enabling a user to define said target groups, specify trigger conditions and actions to be executed for a target member group and generating data representing said target groups, specify trigger conditions and actions to be executed;
communicating said data over a network connection to a server device; and,
said server device receiving said data representing said defined one or more of said target groups, specified trigger conditions and actions, and updating a means for storing said received data.

15. The method as claimed in claim 14, further including enabling a user to define said target groups, specify trigger conditions and actions to be executed for a target member group via a browser device.

16. The method as claimed in claim 14, wherein said server performs: initiating update of said storing means with received target group definition and adding new target groups for storage.

17. The method as claimed in claim 14, wherein said server performs: initiating update of said storing means with said received information representing a trigger condition, each trigger condition having an associated ID.

18. The method as claimed in claim 17, wherein a trigger condition comprises: a specified time or date, a condition is a specified event, a number of participants in a given meeting, a specified behavior of a participant or, attendance of a specified participant, and combinations thereof.

19. The method as claimed in claim 17, wherein executing comprises: receiving an action execution signal, and in response, determining participants of said specified target group and, performing a defined action in response for all members defined in said target group.

20. The method as claimed in claim 19, wherein said monitoring comprises: scanning through defined invocation triggers until one resolves true; and, generating said action execution signal in response.

21. The method as claimed in claim 19, wherein a trigger condition is a Boolean combination of more than one trigger conditions specified by unique IDs associated with said trigger conditions, said monitoring including: scanning through defined invocation triggers comprising said Boolean combination until it finds a combination resolving true, and generating said action execution signal in response.

22. The method as claimed in claim 19, wherein said Boolean combination is specified by unique IDs associated with said trigger conditions of said combination.

23. The method as claimed in claim 14, wherein said server performs: initiating update of said storing means with said received information representing actions to be executed.

24. A program storage device readable by a machine, tangibly embodying a program of instructions executable by the machine to perform method steps for conducting an on-line meeting, said method steps comprising:
storing data relating to a target group of users participating in an on-line meeting, said data including information representing an action to be executed for said target group and, data including information representing a trigger condition for automatically executing said action;
monitoring for occurrence of said trigger condition; and,
executing said action for said target group participants upon detecting occurrence of said trigger condition.

25. A method for sending messages to a group of users of indeterminable size, said users comprising attendees of an on-line meeting and having associated devices for communicating messages over a network connection, the method comprising the steps of:
inviting two or more users to an event;
enabling a first user to initiate delivery of a data object to devices associated with the event's attendees; and,
delivering the data object to devices for only those users who actually attend the event.

26. The method as claimed in claim 25, further including the step of enabling the first user to specify conditions that must be met in order for the delivery to be executed.

27. The method as claimed in claim 26, further including the step of enabling the first user to specify condition-qualified actions to be executed when a prescheduled event occurs.

28. The method as claimed in claim 27, wherein a specified condition-qualified action to be executed when a prescheduled event occurs comprises: an action to be executed at the time an event occurs, along with conditions relating two or more users actually attending the event.

29. The method as claimed in claim 28, wherein a condition relating two or more users actually attending the event comprises determining whether one of said users has attended the event.

30. The method as claimed in claim 25, whereby said two or more members comprise a group, said group including one or more of: those members who actually attend the given event, those members who actually attend the given event and arrive late to said event, those members who attend the given event for a specified amount of time, those members who are at a specified location.
